(19) United States
(12) Patent Application Publication
(10) Pub. No.: US 2003/0001017 A1
(43) Pub. Date: Jan. 2, 2003

(54) Bar code reader

(75) Inventor: Kazuhiko Konda, Chuo-ku (JP)

Correspondence Address: OLIFF & BERRIDGE, PLC, P.O. BOX 19928, ALEXANDRIA, VA, 22320, US

(73) Assignee: MEDIA PORTAL JAPAN CO., LTD., Chuo-ku (JP)

(21) Appl. No.: 10/160,041

(22) Filed: Jun. 4, 2002

(30) Foreign Application Priority Data
Jun. 14, 2001 (JP) 2001-180645

(51) Int. Cl. G06K 7/10; G06F 17/00; G06F 19/00

(52) U.S. Cl. 235/462.15

(57) ABSTRACT

The present invention makes it possible to use a bar code-URL converting service with a simple operation on a cellular telephone. The bar code reader relating to the present invention comprises: a URL memory portion for storing server URLs in advance; a device type information memory portion for storing device type information relating to the connected cellular telephone; an operation command memory portion for storing operation commands for each type; a command generating portion for generating operation commands corresponding to the device type information on the basis of the contents stored in the operation command memory portion; and a combining portion for combining the output of the URL memory portion and the output of the command generating portion with the output of the bar code reading portion. The cellular telephone receives data comprising the bar code, URL, and command, and automatically shifts to Internet mode.

### BACKGROUND OF THE INVENTION

1. Field of the Invention

The present invention relates to a bar code reader used for reading bar codes printed on newspapers, magazines, or advertising leaflets and accessing a prescribed server.

2. Description of the Related Art

A large number of servers is connected to the Internet and provides an assortment of content. Various search engines are provided for selecting and accessing a desired one from among those servers. Apart from that, URLs are printed on newspapers magazines, and advertising leaflets apart from the Internet to appeal for access by users. In order to be actually accessed by users, the content on those servers (web sites) must be interesting and the sites must also-be easy to access.

The use of bar codes is a method for making it easy to access a prescribed URL Specifically, bar codes are printed on paper media such as newspapers, magazines, and advertising leaflets. These are read with a bar code reader connected to a personal computer and converted to URLs, and a browser is automatically started and jumps to the prescribed URLs. This is a simple and sure access method and is expected to become widely disseminated in the future.

A conventional method for accessing a prescribed server based on a bar code (bar code-URL conversion method) is a method wherein a personal computer sends a bar code number received from a bar code reader to a predetermined bar code-URL converting server, receives the converted URL, and accesses the prescribed web server on the basis thereof.

It is presently possible to access the Internet using cellular telephones as well as personal computers. In terms of the number of users, it is said that more users use cellular telephones than personal computers. Consequently, it would also be desirable to be able to access prescribed servers based on bar codes with cellular telephones.

However, accessing the Internet with a cellular telephone requires the user to press a number of buttons to display a menu screen for inputting URLs. While this type of operation is relatively easy for users accustomed to it, it is complicated for first-time uses and the operations must be performed with reference to an operations manual. The fact that operating procedures are different for each make of cellular telephone also complicates those operations. While inputting the URL itself can be easily performed with a bar code, the procedures for displaying the URL input screen are complex and annoying and the particular convenience of the bar codes is lost.

A method enabling the use of a bar code-URL conversion service with simpler operations for cellular telephones is required.

### SUMMARY OF THE INVENTION

In view of the foregoing, it is an object of the present invention to provide a bar code reader which can use a bar code-URL conversion service with simple operations for cellular telephones.

The bar code reader relating to the present invention comprises: a bar code reading portion for reading bar codes; a URL memory portion for storing server URLs in advance; a device type information memory portion for storing device type information relating to the connected cellular telephone; an operation command memory portion for storing operation commands for each type; a command generating portion for generating operation commands corresponding to the abovementioned device type information on the basis of the contents stored in the abovementioned operation command memory portion; a combining portion for combining the output of the abovementioned URL memory portion and the output of the abovementioned command generating portion with the output of the abovementioned bar code reading portion; and a communications portion for sending the output of the abovementioned combining portion to the abovementioned cellular telephone.

### BRIEF DESCRIPTION OF THE DRAWINGS

FIG. 1 is a functional block diagram of a bar code reader relating to an embodiment of the invention;

FIG. 2 is a flowchart for initializing the bar code reader relating to the embodiment of the invention;

FIG. 3 is a flowchart of the procedure for adding commands and a URL to the bar code number in the bar code reader relating to the embodiment of the invention;

FIG. 4 shows sample commands;

FIG. 5 shows other sample commands;

FIG. 6 shows an example of a system to which this bar code reader is applied; and

FIG. 7 shows an example of the processing procedures in this system.

### DESCRIPTION OF THE PREFERRED EMBODIMENTS

Preferred embodiments of the invention will be explained with reference to the drawings.

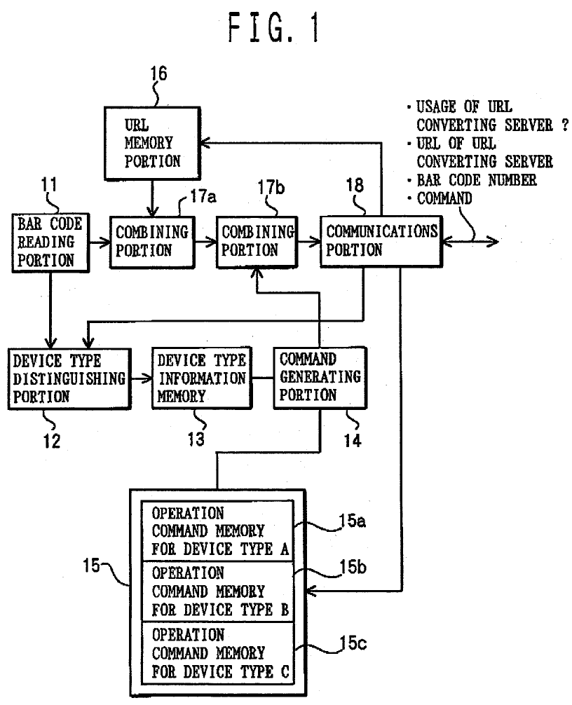

FIG. 1 is a schematic of the bar code reader relating to a first embodiment of the invention. A bar code printed on a newspaper, magazine, or advertising leaflet is read with the bar code reading portion 11. To the bar code read, the URL of the bar code-URL converting server (discussed in detail below) from the URL memory portion 16 is added in the combining portion 17a, and then commands corresponding to the type of cellular telephone (or portable terminal) connected to the bar code reader are added in the combining portion 17b. The data generated in the bar code reader (including whether to use a URL converting server, the URL of the URL converting server, the bar code number, and operation commands for the cellular telephone) are sent to the cellular telephone through the communications portion 18. Upon receiving this data, the cellular telephone, not shown, automatically displays the URL input screen, receives the URL (including the bar code number) of the URL converting server, and accesses the URL converting server, and also receives the URL converted by the URL converting server, accesses this URL, and automatically displays the web screen. In this way, the desired web screen can be displayed on the screen of the cellular telephone with a single operation of reading a prescribed bar code with the bar code reader.

The commands for displaying the URL input screen vary among different types of cellular telephones. For this reason, functional blocks numbered 12 to 15 are established the type distinguishing portion 12 distinguishes the type of cellular telephone connected and stores those results in the device type information memory 13. The command generating portion 14 generates commands for each type . on the basis of information in the memory 13. The operation commands for each type are stored in advance in the memory 15 (15a through 15c.)

Moreover, the memory 15 and URL memory portion 16 can receive updated data from outside the system and automatically overwrite their contents.

It is also necessary to consider that the URL of the URL converting server will be updated at the convenience of the service provider and that corresponding operation commands will be added if new cellular telephones are released. At such times, it would be very convenient for the user if it were possible to automatically update the contents of the bar code memory 15, 16 and advantageous with regard to maintaining bar codes.

Those procedures are generally as follows.

A cellular telephone sends a table update request to an information server, not shown. The timing for the update request may be, for example, at the initialization of the cellular telephone, when the telephone is powered on, when a prescribed operation is performed, periodically, after every given number of readings, before the second time the process is performed (the first time, a primary converting server is accessed, a secondary converting server is accessed for the second time and later). Moreover, the cellular telephone may also send an update request in response to a request from the bar code reader.

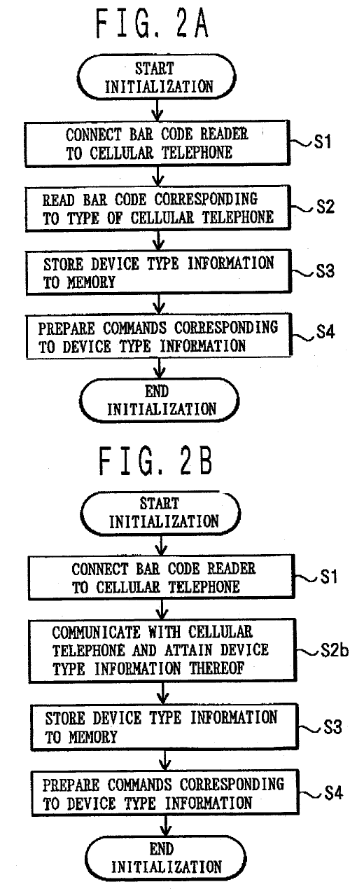

FIG. 2(a) and (b) show the procedures for distinguishing the type of cellular telephone connected.

In FIG. 2(a), the bar code reader in FIG. 1 is connected to a cellular telephone (S1), and then the bar code corresponding to the type of cellular telephone connected is read (S2). A sheet whereon bar codes for each type are printed is attached to the bar code reader. The following items, for example, are printed on this sheet.

| | |
|---|---|
| Type A | Bar code A |
| Type B | Bar code B |
| Type C | Bar code C |

If the item connected is Type A, for example, the bar code A is read with the reading portion 11 and the data for that bar code A are stored in the memory 13 (S3). The command generating portion 14 prepares corresponding commands on the basis of the contents of the memory 13 (s4). When the data in the memory 13 comprise the bar Code A, the command generating portion 14 assembles commands stored in the operation command memory 15a for type A and generates commands.

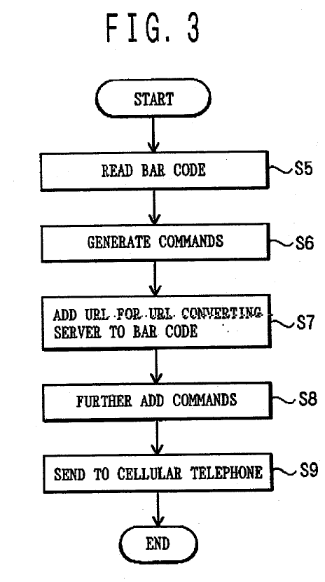

FIG. 2(b) shows the procedures for communicating with the cellular telephone and receiving the type code thereof instead of using a sheet whereon bar codes are printed. The processing other than Step S2b is the same as the case discussed above * FIG. 3 shows the procedures for generating data for accessing a prescribed UMM with the bar code reader.

S5: A bar code printed on a newspaper, magazine, advertising leaflet, or the like is read with the bar code reader. The bar code number included in the bar code is output from the reading portion 11.

For example, the following bar code number is output.

4976680789305

S6: The command generating portion 14 generates corresponding commands. Moreover, it is also possible to generate commands in advance, store these in non-volatile memory, and read commands from the non-volatile memory each time the bar code is read.

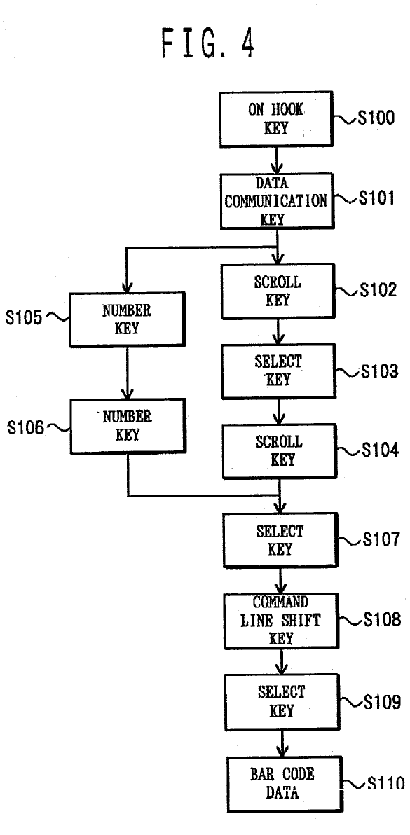

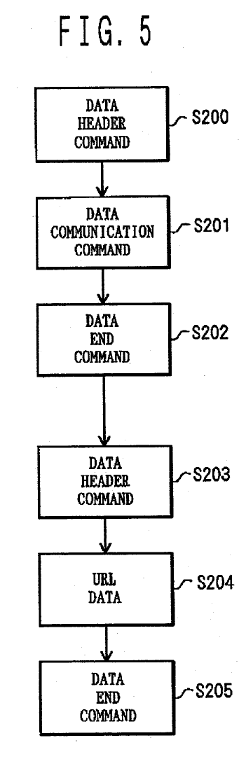

The commands are as shown in FIGS. 4 and 5.

FIG. 4 shows an example of commands corresponding to keys on the cellular telephone. The URL input screen can be displayed by adding the commands from S100 to S109. Moreover, selection methods include using the scroll key (S102 to S104) as well as making a section selection directly with the number keys (S105, S106); either may be used.

FIG. 5 shows an example of commands for direct input of commands and/or data from outside the system. The data embedded between the data header command S200, S203 and the data end command S202, S205 are interpreted either as a command S201 or URL data s204 by the cellular telephone depending on the format.

The abovementioned commands are represented as [CM].

S7: The URL for the URL converting server is added to the bar code. Here, this indicates the server which will convert the bar code.

The data, http://www.mediapj.com/i=php?k=01&s=9&b=, are stored in advance to the URL memory portion 16. In this case, the following data are generated in Step S7.

http://www.mediapj.com/i=php?k=01&s=19&b=4976680789305

Moreover, http://www.mediapj.com/ is the URL for the URL converting server. i=php?k=01&s=19&b=is an option for requesting that the bar code be converted to a URL.

S8; The commands generated in step S6 are added. The following type of data is thereby attained.

[CM] http://www.mediapj.com/i=php?k=01&s=19&b=4976680789305

S9. The data attained are sent to the cellular telephone.

The cellular telephone receives data from the bar code reader, displays the URL input screen on the basis of the above-mentioned [CM] portion, and inputs the URL included in the data received to that screen, and accesses the URL converting server on the basis of the pertinent URL.

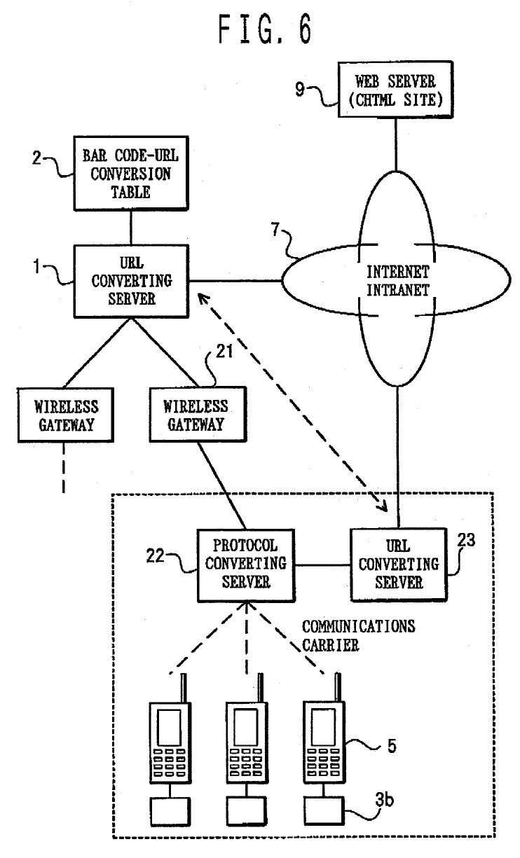

FIG. 6 shows the overall constitution of a system to which this bar code reader is applied. This system has the purpose of reading a bar code and accessing the prescribed site. The bar code readers 3b are connected to the cellular telephones 5 and can read bar codes printed on media. A bar code printed on media such as a newspaper, magazine, or advertising leaflet is read by any of the bar code readers 3b, then the URL converting server 1 is accessed, and the URL corresponding to the bar code number is acquired. The client can access the desired server 9 on the basis of the acquired URL. The URLs corresponding to the bar codes printed on the media M are determined in advance and the correlations thereof are stored in advance in the bar code-URL converting table 2. For example, if a bar code showing the site of a company is printed in newspaper advertising, the user can be guided to that company's site with a simple operation. Moreover, “URL” is an abbreviation for “uniform resource location” and describes the locations and titles of resources present throughout the Internet in a uniform format. Specifically, the URL shows the addresses for resources present on a computer network. The cellular telephone 5 accesses a wireless gateway 21 through a protocol converting server 22, which is established by the communications carrier, and then accesses the URL converting server 1.

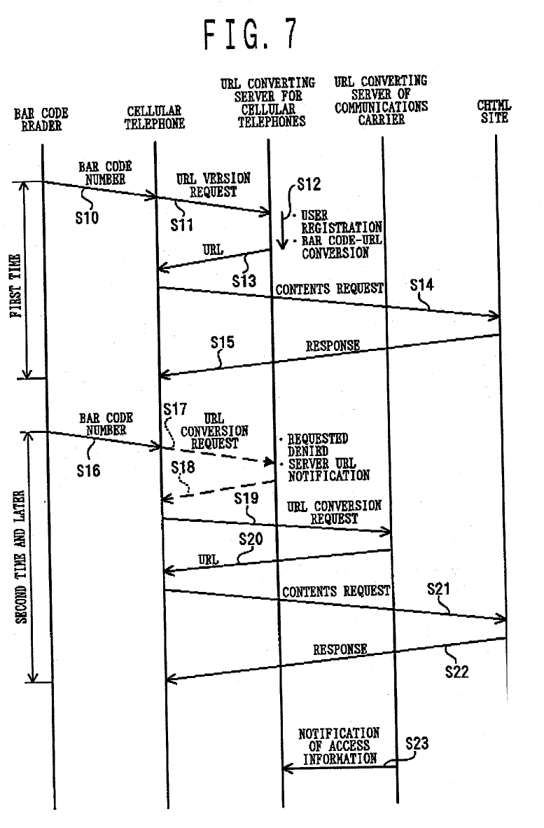

FIG. 7 is a process flow chart for portions relating to the cellular telephone. As understood from this drawing, the processing procedures are different in the case where the cellular telephone 5 first accesses the URL converting server 1 (S10 through S15), and in the case where the cellular telephone accesses the server for the second and later times (S16 through S23). This is in order to reduce the load on the URL converting server 1 and/or the wireless gateway 21, and protocol converting server 22 when a large number of URL conversion requests is generated. In other words, the same type of URL converting servers 23 are provided on the communications carrier side and this causes the load to be distributed. Also, this makes it easy to protect the privacy of the cellular telephone users. By having users access the URL converting server 1 initially, the administrator of the URL converting server 1 can manage the users of the bar code-URL converting server. An explanation for FIG. 7 follows.

First Time Access

S10: The scanned bar code number is sent to the cellular telephone 5.

S11: A request to convert the pertinent bar code number to a URL is sent to the URL converting server 1 for cellular telephones. As discussed above, the pertinent request is sent to the server appropriate tot the type of client.

S12: The user is requested to register because this is a first time access. The user inputs information such as his or her name, address, telephone number, and email address. Afterwards, the bar code number sent is converted to a URL.

S13: The converted URL is sent to the cellular telephone.

S14: Contents are requested from the CHTML site on the basis of the URL received.

S15: The CHTML site responds to the client and sends contents.

Second Time and Later Access

S16: The scanned bar code number is sent to the cellular telephone 5.

S17: A request to convert the pertinent bar code number to a URL is sent to the URL converting server 1 for cellular telephones.

S18: The URL converting server 1 rejects this request when this is a second time or later access, for example, when the user making the request is already registered. At the same time, notification may be made that the request should be submitted to the URL converting server 23 of the communications carrier. Moreover, Steps S17 and S18 are not necessarily required. For example, if it can be determined whether this is a first time access within the cellular telephone that is the client, the server 23 of the communications carrier may be accessed from the start.

S19; The request to convert the pertinent bar code number to a URL is sent to the URL converting server 23 of the communications carrier.

S20: The bar code number sent is converted to a URL and the converted URL is sent to the cellular telephone.

S21: Contents are requested to the CHTML site on the basis of the URL received.

S22: The CHTML site responds to the client and sends contents.

S23: At a prescribed time, notification of access conditions is sent from the URL converting server 23 of the communications carrier to the URL converting server 1.

With the preferred embodiment of the invention, as discussed above, it is possible to use a bar code-URL converting service with a simple operation just by connecting the bar code reader to a cellular telephone. The plurality of button operations, necessary before now, becomes unnecessary and the bar code-URL converting service can be used easily even by people unaccustomed to the operations. Also, no problems develop even when different types of cellular telephones are connected to the bar code reader.

Moreover, in the explanation above, the case of accessing a bar code-URL converting server with a cellular telephone is used as an example, but the present invention is not limited to this. For example, the present invention can also be applied in the case of accessing a prescribed server directly from a URL included in a bar code.

The present invention is not limited to the foregoing embodiment; various changes are possible within the scope of the invention noted in the claims and needless to say, these are also included in the scope of the present invention.

Also, in this specification, “means” does not necessarily mean physical means and includes cases where the functions of the means are achieved with software. Furthermore, the functions for one means may be achieved with two or more physical means, or the functions of two or more means may be achieved with a single physical means.

What is claimed is:

1. A bar code reader comprising:
a bar code reading portion for reading bar codes;
a URL memory portion for storing server URLs in advance;
a device type information memory portion for storing device type information relating to the connected cellular telephone;
an operation command memory portion for storing operation commands for each device type;
a command generating portion for generating operation commands corresponding to said device type information on the basis of the contents stored in said operation command memory portion;
a combining portion for combining the output of said URL memory portion and, the output of said command generating portion with the output of said bar code reading portion; and
a communications portion for sending the output of said combining portion to said cellular telephone.

2. The bar code reader according to claim 1., wherein said operation command memory portion includes rewritable memory; and
wherein said communications portion receives data relating to said operation commands and writes this to said memory.

3. The bar code reader according to claim 2, wherein said communications portion requests to update data at least at one of the following times or intervals at initialization, periodically, after every given number of readings, and after accessing a specified server.

4. The bar code reader according to claim 1, wherein said URL memory portion includes rewritable memory; and
wherein said communications portion receives data relating to said URL and writes this to said memory.

5. The bar code reader according to claim 4, wherein said communications portion requests to update date at least at one of the following times or intervals: at initialization, periodically, after every given number of readings, and after accessing a specified server.

6. The bar code reader according to claim 1, wherein the URL for a URL converting server is attained from said UMM memory portion when reading a bar code for the first time, and subsequently the URL for the server of a communications carrier is attained.

7. The bar code reader according to claim 1, further comprising a device type distinguishing portion for determining said device type information on the basis of a bar code read by said bar code reading portion, wherein said device type information memory portion stores said device type information determined by said device type distinguishing portion.

8. The bar code reader according to claim 1, further comprising a device type distinguishing portion for determining said device type information on the basis of data from the cellular telephone attained through said communications portion, wherein said device type information memory portion stores said device type information determined by said device type distinguishing portion.
